(19) United States
(12) Patent Application Publication
(10) Pub. No.: US 2007/0182069 A1
(43) Pub. Date: Aug. 9, 2007

(54) Plastic Article Comprising Oriented Effect Magnetizable Pigments

(75) Inventors: Doreen C. Becker, Pleasantville, NY (US); Stephane Rochard, Paris (FR)

Correspondence Address: BASF CATALYSTS LLC, 100 CAMPUS DRIVE, FLORHAM PARK, NJ, 07932, US

(73) Assignee: BASF Catalysts LLC, Iselin, NJ (US)

(21) Appl. No.: 11/627,434

(22) Filed: Jan. 26, 2007

Related U.S. Application Data
(60) Provisional application No. 60/766,618, filed on Feb. 1, 2006.

(51) Int. Cl. B29C 67/00

(52) U.S. Cl. 264/439; 264/440; 264/464

(57) ABSTRACT

Pigments having magnetic properties are manipulated using magnetic fields to produce color patterns. The color patterns may be created in a medium such as a molten plastic or a plastic solution. Once disposed in the flowable medium, the pigments migrate by the influence of magnets after which the pigments remain static due to the drying and/or hardening of the medium. A molded plastic article comprising oriented effect magnetizable pigments is provided. The article may be used to contain cosmetics, personal care products, or foods.

This patent application claims the benefit of pending U.S. Ser. 60/766,618 filed Feb. 1, 2006 in its entirety incorporated herein by reference.

### TECHNICAL FIELD

This patent application is directed to plastic articles containing magnetic pigments. Specifically this patent application is directed to plastic articles containing magnetic pigments wherein the magnetic pigments are oriented by magnetic fields to create varied color effects in the article.

### BACKGROUND

In today's market, merchants are constantly looking for ways to improve the design of consumer products to render such goods unique and attractive and thereby increase revenue by sale of such products. This is balanced against the consumers' goals of purchasing attractive goods at reasonable prices. The market for consumer goods is a competitive one. Consumers choose goods for quality, price, and design, including color. Colors are used to differentiate goods and/or improve the products' aesthetic appeal. As often is the case with plastic articles, color is achieved by incorporating colorants into the plastic during molding or other forming processes. In the coloring of molded plastic articles, the colorants are often solid inorganic pigments. Pigments used to color goods comprise a vast industry.

Regardless of application or industry, merchants understand the importance of color in the sale of goods. Special color effects on articles drive new aesthetic trends, create more dynamic visual impact and improve brand recognition and product differentiation. To achieve color effects, often color effect pigments are employed. Effect pigments, such as pigments that induce iridescence, are used in a range of articles including molded plastics used for automobile or motorcycle finishes; sporting equipment such as helmets, skates, snowboards, skateboards; solid-surface applications such as kitchen countertops, bath vanities, or flooring including tiles; sanitary wares, such as sink basins, shower stalls or bath tubs; and in decorative articles, vases, bowls, containers, films, glitter, home sidings.

Often consumers make color the key reason for purchasing an article. The importance of color is particularly noticeable in consumers' decision for purchasing cars, home goods and home appliances. Merchants realize how making available a range of colors or a selecting a particular color for a specific good can greatly increase consumer appeal and thus revenue. This is evidenced by the plethora of colors offered for goods such as cars; cycles; household appliances including toasters, blenders, coffee makers; solid surfaces such as floor tiles and kitchen countertops; and in color trends dictated by fashion each season.

For instance, today metallic colors pervade fashion and other industries. Goods such as luggage, bags, car ornaments, hair ornaments, lawn ornaments, apparel, foot ware, have all been adorned with metallic colors such as gold, silver and copper. The metallic look is popular in the auto industry. Cars, trucks and motor bikes are decorated with metallic paints, or fixtures which employ metallic colors. Likewise, metallic colors, specifically stainless steel, are highly popular in home appliances such as kitchen appliances including coffee makers, refrigerators, ovens, dishwashers, toasters, etc.

Marketing strategies have been developed that use color as a tool in attracting a specific gender to a good or in inviting and not alienating the gender to goods that have traditionally been geared to the opposite gender. For instance, today dark or neutral colors are used to invite males to purchase goods such as home wares, which had traditionally been purchased by females. Similarly, electronic casings such as casings for computers, telephones, portable music devices, digital organizers, etc. have been colored in bright colors to entice females to purchase those products.

The wide range of colors and color effects in the marketplace correlates to the advances in pigment technology. Pigments exist in both natural and synthetic forms. As mentioned above, color effect pigments are one type of pigment presently used to color articles. Normally metal oxides and variations thereof are used to provide these color effects. The color effect pigments are valued for imparting luster or pearlescence. For instance, nacreous pigments produce pearl-like, metallic, and iridescent effects. A widely used type of color effect pigment comprises muscovite mica platelets coated with a metallic oxide, such as titanium dioxide. A relatively thin titanium dioxide coating produces a pearl-like or silvery luster. Mica platelets with thicker coatings produce color, even though the components are colorless, through the phenomenon of light interference. This type of coated platelet is known as an interference pigment. The color, called the reflection color, is seen most effectively by specular or mirror-like reflection, where the angle of reflection equals the angle of incidence. The reflection color is a function of optical thickness, i.e. the geometrical thickness times the refractive index, of the coating. Optical thickness of about 80 nm to about 140 nm produce reflections which may be called white, silvery or pearly while optical thicknesses of about 190 nm or more produce color reflections.

The pearlescent pigments which are most frequently encountered on a commercial basis are titanium dioxide-coated mica and iron oxide-coated mica pearlescent pigments. It is also well known that the metal oxide layer can be overcoated to achieve various desired effects. For instance, Linton, U.S. Pat. No. 3,087,828, describes mica coated with various oxides including those of titanium, iron, cobalt and chromium over which, if desired, a layer of calcined titanium dioxide can be positioned. Brand, U.S. Pat. No. 3,711,308, describes mica coated with a first layer which is a mixture of oxides of titanium and one or more metal oxides which can be, for instance, the oxides of iron, chromium and/or cobalt and a second layer of titanium dioxide. Franz, U.S. Pat. No. 4,744,832, describes coating mica with a layer of titanium dioxide and calcining to form two layers, an inner titanium dioxide layer and an outer pseudobrookite layer. A second layer of iron oxide is deposited and the pigment is recalcined.

Effect pigments imparting nacreous or metallic effects need not only be mica-based, but may be glass-based or comprise other types of platelets. Commonly assigned U.S. Pat. Nos. 6,794,037, 6,800,125 and 6,821,333 disclose color effect materials. The effect materials are composed of a plurality of encapsulated substrate platelets in which each platelet is encapsulated with a highly reflective layer which acts as a reflector to light directed thereon, a spacer layer which is selectively transparent to light directed thereon, and optionally an iron oxide layer which may either be on the spacer layer or the highly reflective layer when present.

Suitable highly light reflective layers may include for example, silver, gold, platinum, palladium, rhodium, ruthenium, osmium, iridium, or an alloy thereof. Suitable spacer pigment layers may include metal oxide, nitride, fluoride or carbide or polymer.

Also, commonly assigned U.S. Pat. No. 6,875,264 discloses multi-layer effect pigments. The pigments include a transparent substrate, a layer of high refractive index material on the substrate such as mica or glass flake, and alternating layers of low refractive index and high refractive index materials on the first layer with the total number of layers being an odd number of at least three.

Engelhard Corporation (now BASF Catalysts LLC) has been actively involved in the pigment arts. Black Olive™ pigment, publicized since 2002, is one example of Engelhard's wide array of pigments. Black Olive™ is a black mica-based effect pigment having champagne undertones. The pigment displays shades of brown-black that had once been difficult to achieve with mica-based pigments and thereby produces a black, lustrous, pearlescent finish. Black Olive™ has been used in many diverse applications including molded-in plastic or coatings for electronic equipment, appliances, sporting goods and packaging, specialty decorative coatings and inks, coatings and inks for leather goods, solid-surface applications (i.e., countertops and flooring).

In light of the ever-increasing importance of color and color effects to entice consumers there is a continuous need to meet the full potential of pigment technology. Pigment technology must continue to evolve in light of consumer demand. For instance, the market for faux goods that appear equivalent to the natural object is vastly increasing. Today's consumers are price conscious. They desire quality goods or goods that appear to be of high quality while also being reasonably priced. Faux goods of good quality may often be purchased at a reduced price with respect to the price of the natural goods.

A clear illustration of consumer demand is seen in the home goods market. Homeowners and homebuilders want quality or the appearance of quality wares when constructing or remodeling a home. For instance solid-surfaces such as kitchen countertops and bathroom vanities made of marble or granite are highly valued in homes and can impart a luxurious look to the home and also increase the value of the home. Such natural products are expensive. The costs associated with producing faux wares that mimic the natural appearance often can be drastically cheaper than purchasing the same quantities of the natural goods. Thus purchasing faux goods mimicking the look of marble or granite may be ideal to many consumers.

Along the same lines, the development of metallic colors such as those that resemble metals, e.g. stainless steel, can be highly desirable in the home goods market. For instance, formed goods having a metallic appearance may be used to mimic stainless steel and be used in home appliances such as coffee makers, refrigerators, ovens, dishwashers, toasters, etc. By developing colors that resemble stainless steel, such colors can be incorporated into plastics articles such as appliance panels to replace costly stainless steel used in many homes today.

It is desirable to create new pigment combinations to color articles and increase the articles' appeal. It is also desirable to create new color variations and/or color designs and patterns using pigments presently known in the pigment arts. Equally desirable is a method to color an article with pigments to create new color variations, effects and/or color designs and patterns. For instance, as mentioned above, it is desired to create faux products that mimic costly natural wares.

While U.S. Pat. Nos. 5,223,360 and 6,759,097 and commonly assigned Canadian Patent 2,161,816 teach the use of magnetizable pigments in coatings and films, they do not teach or suggest shaped articles having effect magnetizable pigments therein.

### SUMMARY

Unique color patterns and products containing the same are created using magnetic pigments. The magnetic pigments are oriented in the products during formation thereof using magnetic fields to produce various color effects and color patterns. For instance, unique color patterns may be created in an article by disposing the magnetic effect pigments within a fluid medium, orienting the pigments and allowing the medium to dry or harden into a shaped article.

### DETAILED DESCRIPTION

A process is provided for producing color patterns and products possessing such color patterns. The color patterns are created using magnetic pigments wherein the orientation of the pigments can be manipulated using magnetic fields. The effect pigments employed in the present patent application will have magnetic properties. These magnetic pigments possess a substrate being any encapsulatable smooth platelet. Examples of usable platelets include mica, aluminum oxide, bismuth oxychloride, boron nitride, glass flake, iron oxide-coated mica or glass, silicon dioxide and titanium dioxide-coated mica or glass. The size of the platelet-shaped substrate is not critical per se and can be adapted to the particular use. In general, the particles may have average largest major dimensions of about 5-500 microns, in particular 5-100 microns. Their specific free surface area (BET) is in general from 0.2 to 25 m²/g.

Useful effect magnetic pigments typically will contain a platelet substrate as above described with one or more metal or metal oxide layers disposed thereon at least one of which will have magnetic properties. For example, pigments particularly useful are pigments based on mica platelets that have two metal oxide layers thereon. The first layer may contain titanium oxide, iron oxide, cobalt oxide, or chromium oxide or mixtures thereof. The second layer may contain titanium dioxide or iron oxide or both. For a discussion of mica-based magnetic pigments see commonly assigned U.S. Pat. No. 6,361,593, which is incorporated by reference herein.

As described in '593, the micaceous platelet substrate, the titanium, iron, cobalt and chromium reagents, the coating conditions and procedures and calcining conditions and procedures are all individually well known in the art. See, e.g., the aforementioned Linton U.S. Pat. No. 3,087,828 as well as U.S. Pat. No. 3,087,829. In general, the mica is slurried in a suitable medium, preferably water, which contains or to which is added a metal containing reagent and the hydrous form of the metal oxide is coated on the mica platelets by suitable adjustment of the pH.

The hydrous form of the oxide is then converted to the oxide by calcination. It is also well known to employ various reagents and conditions in order to cause the titanium dioxide to be in the anatase or rutile crystalline form. In this procedure a dual layer configuration is deliberately employed and metal oxides are selected in each layer.

Possible oxides present in the initial layer on the mica substrate is a mixture of titanium dioxide, iron dioxide and one or both of cobalt oxide and chromium oxide. The mica is first coated with a hydrous mixture of the metal oxides which is then calcined. The mica can be coated with the individual oxides in any desired order and if desired, the coated mica can be recovered, washed and/or dried after each metal is deposited. It is most convenient and therefore preferred to coat the mica with the metal oxides seriatim without isolation of each intermediate product by changing the pH with a suitable reagent such as sodium hydroxide or hydrochloric acid. For example, of the hydrous metal oxides of the first layer, the hydrous titanium dioxide is coated on the mica substrates at the most acidic pH. Raising the pH will then cause the hydrous iron oxide and finally the cobalt and/or chromium oxides to deposit.

The two coating layers on the mica pigments in combination have an interference color thickness. This generally ranges from about 60-150 nm. In general, the layer closest to the mica constitutes about 2 to 25% of the thickness of the two coating layers and in another range about 10 to 20%.

In the first coating layer, the titanium dioxide is about 20 to 90 wt. % based on the total weight of the oxides, and in another range about 40 to 60%. The iron oxide is about 5 to 40% and in another range about 20 to 30% and the chromium and/or cobalt constitutes the balance of about 5 to 40% and in another range about 20 to 30%.

Another example of useful pigments is glass-based pigments that may be formed using any kind of glass. A discussion of glass-based magnetic pigments is disclosed in U.S. Pat. No. 5,436,077, which is incorporated by reference herein. As described in '077, conventional glasses can be employed, including, e.g., glasses used for conventional glass sheets, E-glass, lead glasses, and glasses for acid-resistant containers. When the glass flake is used, on its surface may be a metal covering layer on which may be formed a dense protective covering layer of a metal oxide. In one embodiment, the glass flake may have a diameter (or particle size in the direction perpendicular to the thickness) of about 10 to 1,000 μm, a thickness of about 0.1 to 10 μm, and an aspect ratio of 5 or above. At least one of the layers disposed on the glass flake will have magnetic properties.

The metal covering layer formed on the flake of glass preferably has a thickness of formed 35 to 500 nm.

As examples of metals usable for the metal covering layer, mention may be made of noble metals, such as gold, silver and platinum, and base metals, such as nickel, copper, chromium and zinc. Other base metals may include iron, tin and lead. It is also possible to use an alloy of such metals.

There is no particular restriction on the method of forming the metal covering layer, and a suitable method can be selected in accordance with the kind of metal to be covered, and with the desired gloss and color tone. For example, a chemical plating (e.g., nonelectrode plating) can be employed.

The dense protective layer of a metal oxide preferably has a thickness of about 20 to 1,000 nm. The layer is preferably made of SiO₂, SiO₂—Al₂O₃, Al₂O₃, TiO₂, ZrO₂, or the like.

The dense protective layer can be formed preferably by using a metal alkoxide, in which a glass flake having formed thereon a metal covering layer is maintained for a predetermined period of time in an alkaline suspension containing a metal alkoxide, water and an alcohol, and the flake is then separated therefrom and subjected to firing.

The ratio (based on mole) of water to metal alkoxides to be admixed is preferably from 25 to 100 (water:metal alkoxides=25-100:1). In the mixture, alcohols are contained preferably at a percentage of 34% by weight or more (but less than 100%), in particular from 40 to 90% by weight. When the percentage is less than 34%, there may be resulted an incomplete mixing and the desired properties may not be attained, whereas a percentage greater than 90% could be disadvantageous with regard to cost.

It can be advantageous to at first admix a metal alkoxide, water and an alcohol, and then to supply glass flakes into the mixture. The glass flakes are supplied to the mixture preferably in an amount of about 100 to 1,000 parts, per 100 parts by weight of metal alkoxides. It can be advantageous with regard to the uniformity of the covering to adjust pH of the mixture after the supply of the glass flakes. (If desired, the mixture can be rendered alkaline prior to the supply of the glass flakes.) A pH in the range of from 10 to 12 can be particularly advantageous. When the pH is lower than 10, there may be resulted an undesirably low reaction rate. When the pH is higher than 12, there may be formed a metal oxide covering layer having poor density because of excessively high reaction rate.

After the supply of the glass flakes, the resulting mixture is stirred preferably in such a manner the glass flakes could remain unprecipitated. The dispersed state of the glass flakes is maintained preferably for 1 to 4 hours.

During the stirring, a metal oxide deposits on the surface of the glass flakes, thereby forming a film.

Thereafter, the glass flakes are separated from the liquid by an appropriate means, such as filtration, centrifugation, or the like. The separated glass flakes are then dried after being washed with water, where necessary.

The resulting glass flakes are then subjected to firing, whereby the deposited metal oxide layer is dehydrated and fine pores contained therein disappear. Thus, there can be obtained glass flakes having thereon a metal covering layer on which is formed a dense protective layer of a metal oxide. The temperature of the firing may be varied depending, e.g., on the kind of metal in the metal covering layer, and the kind of metal oxide in the metal oxide layer. In usual cases, the firing can be carried out at a temperature of about 500° to 600° C., in particular, 530° to 580° C. When the firing temperature is too low and/or the firing period is too short, it will not be possible to fully attain the effect of increasing the density. On the contrary, when the firing temperature is too high and/or the firing period is too long, the metal in the metal covering layer may migrate into the glass layer in the form of colloid, thus causing the wearing of the metal covering layer and the disappearance of its metallic gloss.

The surface of the glass flake may be treated with, e.g., a silane coupling agent, in order to improve the wetting property and adhering property of the flake per se and of an article containing the flake. Any silane coupling agent can be used for the treatment.

The article containing the flake is prepared by incorporating the glass flake provided with the dense protective covering into an article-forming composition. In the article-forming composition, there can be used any resin components hitherto, including, e.g., melamine-alkyd resins, thermosetting acrylic resins, acrylic lacquers, nitrocellulose lacquers, polyester resins, polyurethane resins, and the like. The composition may be prepared by incorporating various pigments and additives (for example, dispersing agents, antirunning agents, plasticizers, color separation inhibitors, etc.) into a vehicle.

As described above, the magnetic pigments used in the present method may include commercially available pigments such as Black Olive™ pigment made by Engelhard Corporation, Iselin, N.J., (now BASF Catalysts LLC) or Metashine® pigment made by Nippon Glass Fiber, Japan. These and other pigments having magnetic properties are envisioned for use herein. Other useful effect magnetizable pigments include mica coated with TiO₂ and then Fe₃O₄ and mica coated with cobalt ferrite and then TiO₂ and those disclosed in commonly assigned U.S. Pat. No. 6,139,615 incorporated in its entirety herein by reference.

The magnetic pigments may be disposed in a medium to produce products such as those formed from plastic resins. Suitable resins include thermosetting resin or thermoplastics resin. Thermosetting resins harden in the presence of heat. Examples of some thermosetting resins useful herein include, without limitation, epoxy resins, such as resins made from epichlorohydrin and bisphenol A or epichlorohydrin and aliphatic polyols, such as glycerol, and which can be conventionally cured using amine or amide curing agents. Other thermosetting resins include phenolic resins obtained by condensing a phenol with an aldehyde, e.g., phenol-formaldehyde resin, amino resins (such as urea-formaldehyde or malamine-formaldehyde), polyimides (cross-linked and/or glass filled), an alkyd resin, an unsaturated polyester resin, a vinyl ester-series resin, silicone-series resin or the like. Other useful thermosetting matrix materials include polyesters, vinyl esters, aminoplasts, thermosetting polyurethanes, derivatives and mixtures thereof.

Thermoplastic resins which soften upon heating may also have application in the present method. Examples of thermoplastic resins include ionomers resins (ethylenic ionomer resins), ethylene-ethyl acrylate copolymer (abbreviated as EEA), acrylonitrile-acrylic rubber-styrene copolymer resin (abbreviated as AAS), acrylonitrile-styrene copolymer resin (abbreviated as AS or SAN), acrylonitrile styrene copolymer resin (abbreviated as ACS), ethylene-vinyl acetate copolymer (abbreviated as EVA), ethylene-vinyl alcohol copolymer resin (abbreviated as PVAL), acrylonitrile-butadiene-styrene copolymer resin (abbreviated as ABS), polyvinyl chloride resin (abbreviated as PVC or PVW), chlorinated polyethylene resin (abbreviated as CPE), acetate fiber resin (cellulose acetate resin), polyethylene tetrafluoride resin (abbreviated as PTFE), ethylene tetrafluoride-perfluoroalkyl vinyl ether copolymer resin (abbreviated as PFA), ethylene tetrafluoride-ethylene copolymer resin (abbreviated as ETFE), polyethylene trifluoride chloride resin (abbreviated as CTFE), polyvinylidene chloride, polyvinylidene fluoride (abbreviated as PVF), polyoxymethylene resin (abbreviated as PCM), nylon 6 (abbreviated as PA6), nylon 66 (abbreviated as PA 66), nylon 610 (abbreviated as PA 610), nylon 11 (abbreviated as PA 11), nylon 12 (abbreviated as PA 12), nylon 46 (abbreviated as PA 46), a specific type of nylon (Raney commercially available from Mitsubishi Chemical Corp. (former Mitsubishi Gas Chemical Co., Ltd.), polyarylate resin (aromatic polyester resin, abbreviated as PAR), thermoplastic polyurethane elastomer (abbreviated as TPU), thermoplastic elastomer (abbreviated as TPE), wholly aromatic polyester resin (with another name of polyoxybenzoyl resin, abbreviated as POB), polyetherether-ketone resin (abbreviated as PEEK), polysulfone resin (abbreviated as PSF), polyether sulfone resin (abbreviated as PES), polysulfone resin (abbreviated as PSU), high density polyethylene resin (abbreviated as HDPE), low density polyethylene resin (abbreviated as LDPE), linear low density polyethylene resin (abbreviated as L-LDPE), polyethylene terephthalate resin (abbreviated as PET), polycarbonate resin (abbreviated as PC), polystyrene resin (abbreviated as PS), medium impact polystyrene resin (abbreviated as MIPS), high impact polystyrene resin (abbreviated as HIPS), polyphenylene oxide resin (abbreviated as PPO), polyphenylene ether resin (abbreviated as PPE), styrene-modified polyphenylene oxide resin (abbreviated as modified PPO or styrene-modified PPO), styrene-modified polyphenylene ether resin (abbreviated as modified PPE or styrene-modified PPE), styrene-grafted polyphenylene ether resin (abbreviated as PPE or styrene-modified PPE), styrene-grafted polyphenylene oxide resin (abbreviated as modified PPO or styrene-modified PPO) (the terms “PPO, PPE, modified PPO, modified PPE, styrene-modified PPO and styrene-modified PPE” used herein are generically expressed as styrene-modified PPO (E) resin, polyphenylene oxide (ether) resin, modified (reduced) polyphenylene oxide (ether) resin, modified PPO (E) and the like), polyphenylene sulfide (abbreviated as PPS), polybutadiene resin (abbreviated as PBD), polybutylene terephthalate resin (abbreviated as PBT), polypropylene resin (abbreviated as PP), methacrylic resin (usually called acrylic resin, with an abbreviation of PMMA), methylpentene polymer (abbreviated as PMP), very low density polyethylene resin (abbreviated as VLDPE), ethylene-methyl methacrylate copolymer, polythio ether sulfone resin, polyketone, polyamide imide, modified maleimide resin, ethylene vinyl acetate copolymer-saponified product, ABS permanent electrostatic resin, HIPS permanent electrostatic resin, MIPS permanent electrostatic resin, PS permanent electrostatic resin, PCT resin (polyester resin), polyether imide resin, polyallyl ether ketone, polybutene resin, EMAA resins, polyacrylonitrile, liquid crystal polymers, styrene maleimide copolymer resin, ethylene acrylic acid copolymer resin, silane-crosslinked polymers, liquid crystal polyester resins, biodegradable plastics such as polylactic acid that are derived from corn & soy, and the like.

Once the pigments are incorporated within the medium, magnets are disposed near or in the medium to create a magnetic field to influence the pigments to move. There is no limit as to the number of magnets required in this method as one or more magnets may be employed herein. The magnetic fields may be applied in a variety of ways to create the magnetic fields which affects the movement of the pigments. Thus, the magnets may be permanently fixed or moved relative to the article being formed. One fixed magnet may be employed or a plurality of fixed magnets or a combination of fixed and moving magnets

Specific concentrated patterns may be created in a medium when the magnets are permanently fixed and placed strategically to draw the pigments to a specific location. Unique flowing color patterns may be created by moving the magnets relative to the article being formed. The moving magnets may travel linearly or non-linearly about the article being formed and may have a starting point as well as a destination point. When magnets are moved about the article, the magnets can either move about gradually or rapidly and either at constant times or during timed intervals. For instance, the magnets may be stationary for certain periods of time and moving for other periods of time. Furthermore, combinations of both moving and fixed magnets may be employed to form a multitude of color patterns. Alternatively the article being formed may be moved relative to fixed or moving magnets.

The movement of the magnets and the magnetic field or fields created dictates the configuration of the color patterns. By pulling the pigments in any number of ways, unique and attractive color patterns can be created in the medium.

It should be remembered that simultaneous with the movement of pigments, the medium within which the pigments are disposed gradually hardens and thus layered color patterns may be created during the run of the method. The movement of the pigment with the concurrent hardening of the medium makes it foreseeable that exponential color patterns and numerous dramatic color effects can potentially be produced.

Generally the method of creating products having color patterns involves mixing together a fluid medium and the magnetic pigments to form a combination or mixture. The fluid medium can be a molten resin, a solution of resins in a solvent or a dispersion. The mixture is stirred to disperse the pigments in the medium. The mixture can then be shaped, e.g. molded, into an article. A magnetic field, as described above, is applied near the mixture to influence the movement of the pigments. The fluid medium and pigment mixture is allowed to harden or set into the formed article. After the mixture sets or hardens into an article, unique color patterns are discerned as a result of the pigment migration due to the magnetic field being applied.

Thus, when molded articles possessing unique color patterns are created, magnets may be selectively placed around the mold prior to or while the medium is being dispersed or even after the medium is fully inserted in the mold. Similarly, when articles are formed via extrusion, magnets may be placed adjacent the shaping die. The magnets may be placed upstream and/or downstream the extrusion die. In any case, the magnetic field causes the flow of magnetic particles within the fluid medium during the formation of the article and thereby produces articles possessing unique color patterns.

The present method may be used to create a plethora of items. Some non-limiting examples include granite, marble and even stainless steel to create faux products or create any number of unique designs or color patterns. These designs may be directly disposed within an article including solid surfaces such as countertops, flooring, tiles, laminate flooring; sanitary wares such as bath tubs, shower stalls, toilets, commodes; electronic encasings for computers, telephones, televisions, radios, cameras; product casings such as cosmetic containers, food containers; etc. There is no intent to limit the types of articles which are to be prepared with the present color effects.

The plastic medium used may also be shaped using techniques known in the art including compression molding, injection molding, blow molding, spinning, vacuum forming and calendaring, thermoforming and rotational molding, as well as extrusion into sheets, fibers, rods, tubes and other cross-sectional profiles of various lengths. The present method may also be used in molded plastic components, films, glitter made from the film, casings for electronics or automotive parts as well as packaging and containers. Again, no attempt is made to limit the ways in which the medium is formed or the colors patterns formed by the present method.

The following examples are set forth to illustrate this method.

### EXAMPLE 1

Add 1% Black Olive™ pigment to an epoxy-amine liquid or flowable resin. Stir gently for 3 minutes. Pour pigment and resin mixture into a glass petri dish. A magnet is disposed within the dish or underneath the dish. The flowable resin and pigment mixture was allowed to harden for several hours at room temperature. After the resin hardened, unique color patterns were discerned as a result of the effect pigments gravitating to the magnet.

### EXAMPLE 2

Add 1% Metashine® pigments to an epoxy-amine liquid or flowable resin. Stir gently for 3 minutes. Pour pigment and resin mixture into a glass petri dish. A magnet is disposed within the dish or underneath the dish. The flowable resin and pigment mixture was allowed to harden for several hours at room temperature. After the resin hardened, unique color patterns were discerned as a result of the effect pigments gravitating to the magnet.

What is claimed is:

1. A method of creating effects comprising the steps of:
(a) disposing effect magnetic pigments comprising platelets coated with at least one metal layer or metal oxide layer in a fluid plastic to form a fluid mixture;
(b) altering the orientation of said pigments in the fluid mixture by magnetic fields;
(c) shaping the oriented fluid mixture; and
(d) hardening the shaped oriented fluid mixture.

2. The method of claim 1 wherein the platelets are mica.

3. The method of claim 1 wherein the platelets are glass.

4. The method of claim 1 wherein the platelets are coated with iron oxide.

5. The method of claim 1 wherein the platelets are coated with chromium or oxide thereof.

6. The method of claim 1 wherein the fluid mixture is shaped by molding.

7. The method of claim 1 wherein the fluid mixture is shaped by extrusion.

8. The method of claim 1 wherein the fluid plastic is molten.

9. The method of claim 1 wherein the fluid plastic is a solution or dispersion.

10. The method of claim 1 wherein the plastic is a thermoplastic resin.

11. The method of claim 1 wherein the plastic is a thermosetting resin.

12. The method of claim 1 wherein the plastic is biodegradable.

13. The method of claim 2 wherein the mica platelet has two metal oxide layers thereon.

14. The method of claim 3 wherein the glass platelet has a metal covering layer on the glass and a covering layer of metal oxide over the metal covering layer.

15. A color effect article produced by the method of claim 1.

16. The article of claim 15 wherein the color effect resembles marble or granite.

17. The product of claim 1, wherein the product is molded or extruded.

18. A bottle made of the molded product of claim 17.

19. A molded plastic article comprising oriented effect magnetizable pigments.
